(19) United States
(12) Patent Application Publication
(10) Pub. No.: US 2008/0186730 A1
(43) Pub. Date: Aug. 7, 2008

(54) Annular light pipe

(76) Inventors: Gregg Smith, Vancouver, WA (US); Jeffrey S. Anderson, Camas, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/648,152

(22) Filed: Dec. 28, 2006

Related U.S. Application Data
(60) Provisional application No. 60/756,490, filed on Jan. 4, 2006.

(51) Int. Cl. F21V 7/04

(52) U.S. Cl. 362/555

(57) ABSTRACT

An economical, energy efficient light pipe that illuminates to encircle a button or the like is disclosed. In one embodiment, the light pipe is substantially conical shaped with a substantially convex tip positioned substantially adjacent to a light source. Preferably, the light pipe has a substantially conical-shaped portion that opens into a substantially cylindrical-shaped central portion and then opens further into a substantially conical shaped outer portion defining an outer illumination ring, thereby allowing a single, energy efficient, light emitting diode positioned adjacent to the convex tip to light the entire outer illumination ring.

### CROSS-REFERENCE TO RELATED APPLICATIONS

This application claims priority to U.S. provisional patent application Ser. No. 60/756,490, filed on Jan. 4, 2006.

### FIELD OF THE INVENTION

The present invention relates to light ring, which is also commonly known as a light pipe that illuminates to encircle a button, knob or the like.

### BACKGROUND OF THE INVENTION

Annular light rings, which are also known as “pipes,” are commonly used around buttons and knobs, especially those used as controls in consumer electronic devices and the like. The ring usually illuminates to indicate a status of the button or knob it encircles. For example, a light ring around an elevator button usually illuminates to indicate that the button has been pressed, and turns off when the commanded request has been completed.

It is desirable for light rings to be durable, economical and highly energy efficient, especially when they are used in small, often battery operated, consumer electronics. However, to date, known light rings and their related illumination structures have been costly and not particularly energy efficient.

### SUMMARY OF THE INVENTION

Accordingly, despite the available light pipes, there remains a need for an economical, energy efficient light pipe that illuminates to encircle a button or the like when installed on consumer electronic device. In addition to other benefits that will become apparent in the following disclosure, the present invention fulfills these needs.

The present invention is a light pipe that is preferably substantially conical shaped with a substantially convex tip positioned substantially adjacent to a light source. More preferably, the light pipe has a substantially conical-shaped portion that opens into a substantially cylindrical-shaped central portion and then opens further into a substantially conical shaped outer portion defining an outer illumination ring. The outer illumination ring is preferably positioned within the frame of the consumer electronic device so as to be flush with an outer surface of the consumer electronic device.

### BRIEF DESCRIPTION OF THE DRAWINGS

FIG. 1 is an isometric view of a light pipe in accordance with the present invention installed on a consumer electronic device and encircled by an exemplar knob that pivots about axis 22.

FIG. 2 is an exploded isometric view of the consumer electronic device of FIG. 1 showing possible internal detail.

FIG. 3 is a partial, isometric, cross-sectional view of the consumer electronic device of FIG. 1.

FIG. 4 is a cross-sectional side view of the light pipe of FIG. 1.

### DETAILED DESCRIPTION OF PREFERRED EMBODIMENTS

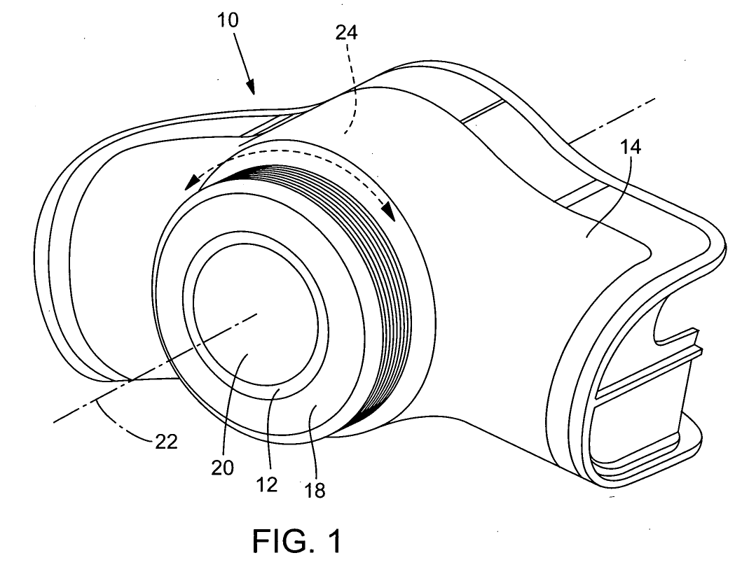

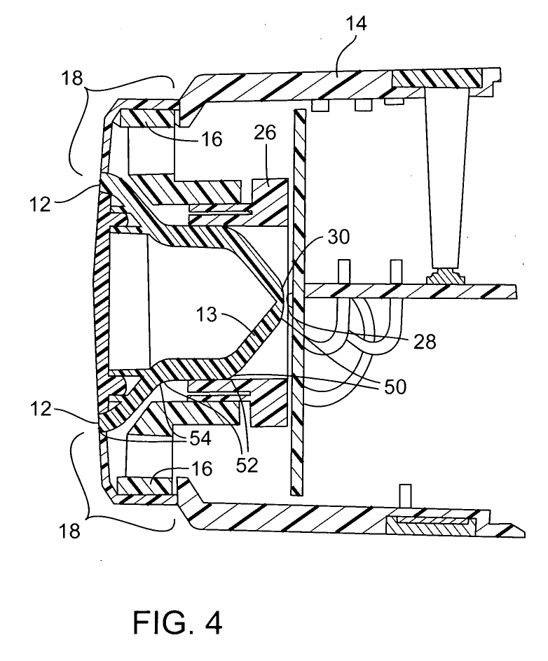

A light ring, or light pipe 13, that illuminates to encircle a button 20, knob or the like installed on an exemplar consumer electronic device 10 is disclosed in FIGS. 1-4.

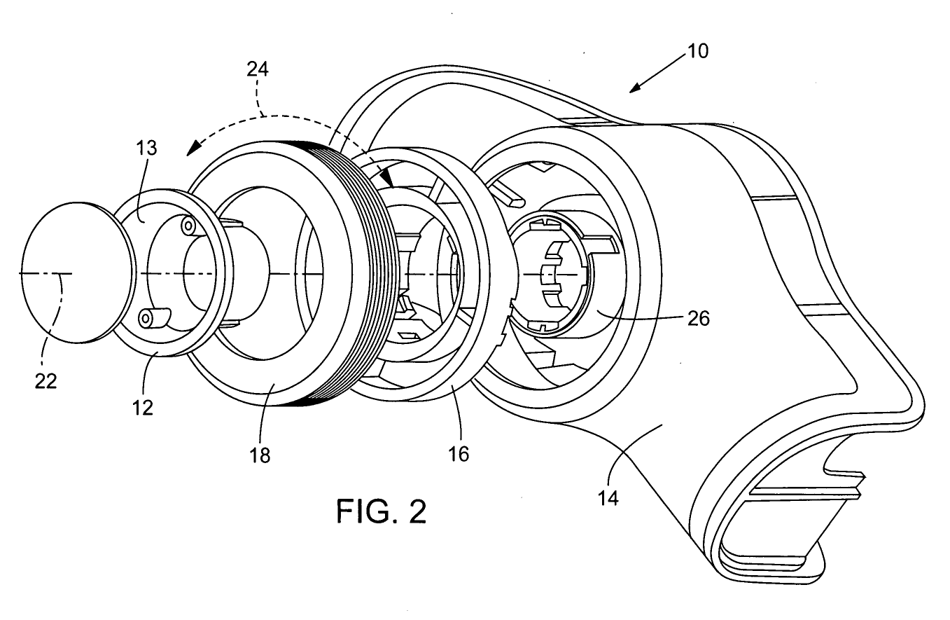

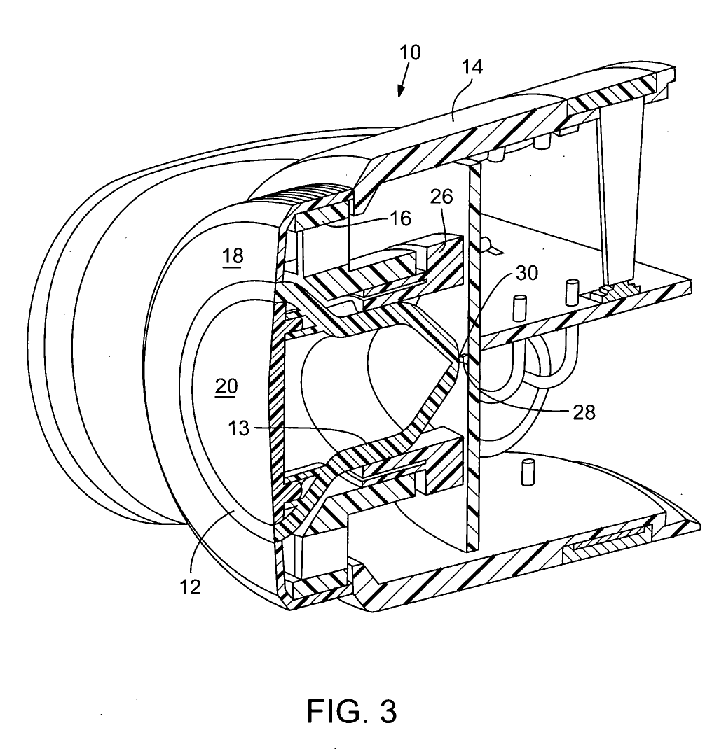

As best shown in FIGS. 2-3, the light pipe 13 is preferably formed of a light carrying conduit that is substantially conical shaped with a substantially convex tip 30 (FIGS. 3 & 4) positioned substantially adjacent to a light source 28.

More preferably, the light pipe 13 has a substantially conical-shaped portion 50 that opens into a substantially cylindrical-shaped central portion 52 and then opens further into a substantially conical shaped outer portion 54 defining an outer illumination ring 12.

The conduit is preferably symmetrical about its longitudinal centerline with the convex tip positioned substantially at the longitudinal centerline. Accordingly, with the light source positioned adjacent to the convex tip substantially near the longitudinal centerline, the entire outer illumination ring is lit with a single source of light.

The outer illumination ring 12 is preferably positioned within the frame 14 of the consumer electronic device so as to be flush with an outer surface of the consumer electronic device 10.

Preferably, the light source is a Light Emitting Diode (“LED”) lamp in electrical communication with common power and activation systems. More preferably, the substantially convex tip 30 is spaced apart from the LED lamp by a defined distance. One known LED lamp that has been found to work particularly well in this environment is manufactured by the Kingbright Corporation as part number APHK1608PBC. Other lamps having similar performance characteristics would likely perform as well.

Preferably, the light pipe 13 is formed with a light transmitting polymer or the like. One product that has been found to work particularly well is manufactured by the GE Plastics Corporation, and sold under the trademark LEXAN 141R. Other polymers and the like having similar properties would likely perform as well.

In addition to the energy and cost saving benefits of the disclosed light pipe, it can also be easily configured to operate within a rotating knob as shown in FIGS. 1-4. For example, the light pipe 13 can be operably secured within a protruding frame portion 26 with a logo face place 22 secured over the opening of in the light pipe 13 as shown. A knob support frame 16 is secured to the frame 14 such that knob 18 is pivotally secured thereto. Accordingly, the knob 18 is pivotable about the longitudinal centerline of the knob and light pipe as shown.

Having described and illustrated the principles of our invention with reference to a preferred embodiment thereof, it will be apparent that the invention can be modified in arrangement and detail without departing from such principles. In view of the many possible embodiments to which the principles may be put, it should be recognized that the detailed embodiment is illustrative only and should not be taken as limiting the scope of our invention. Accordingly, we claim as our invention all such modifications as may come within the scope and spirit of the following claims and equivalents thereto.

We claim:

1. An illuminating light ring assembly comprising;
a light carrying conduit having a substantially conical shape with a substantially convex tip; and,
a light source positioned substantially adjacent to said convex tip.

2. The illuminating light ring assembly of claim 1, wherein said light carrying conduit has a substantially cylindrical-shaped central portion extending from said convex tip.

3. The illuminating light ring assembly of claim 2, wherein a conical portion extends between said convex tip and said cylindrical-shaped central portion.

4. The illuminating light ring assembly of claim 3, wherein a second conical portion extends from said cylindrical-chapped central portion.

5. The illuminating light ring assembly of claim 4, wherein said second conical portion defines an outer ring of said illuminating light ring assembly.

6. The illuminating light ring assembly of claim 5, further including a knob rotatably secured to a consumer electronic device and said outer ring is received within said knob.

7. The illuminating light ring assembly of claim 1, further including a frame defining a consumer electronic device, and said light carrying conduit is operably secured to said frame.

8. The illuminating light ring assembly of claim 1, wherein said light source is a light emitting diode.

9. The illuminating light ring assembly of claim 8, wherein said light source is a single light emitting diode positioned adjacent to and centrally aligned with said light carrying conduit.

10. The illuminating light ring assembly of claim 1, wherein said light carrying conduit is a light transmitting polymer.
